(19) United States
(12) Patent Application Publication
(10) Pub. No.: US 2006/0014584 A1
(43) Pub. Date: Jan. 19, 2006

(54) Game system, management device, game terminal, jack pot payment method, and program

(76) Inventor: Masamichi Iida, Osaka (JP)

Correspondence Address: LOUIS WOO;LAW OFFICE OF LOUIS WOO, 717 NORTH FAYETTE STREET, ALEXANDRIA, VA, 22314, US

(21) Appl. No.: 10/528,030

(22) PCT Filed: Sep. 19, 2003
(86) PCT No.: PCT/JP03/11987

§ 371 Date: Aug. 30, 2005

(30) Foreign Application Priority Data
Sep. 20, 2002 (JP) 2002-275719
Sep. 3, 2003 (JP) 2003-311465

(51) Int. Cl. G06F 17/00

(52) U.S. Cl. 463/26

(57) ABSTRACT

A gaming system, rich in entertainment value, which can unfold a heated game wherein all of the players are passionate about winning a jackpot, while maintaining the appeal of the jackpot in that it is unknown when it will occur, is disclosed. This gaming system comprises a plurality of gaming terminals 1 which collects medals and the like to execute a game and pays out prizes according to the game results and a jackpot management device 2 which is connected to this plurality of gaming terminals to enable communication, executes a special game which is for the sole purpose of jackpot competition in a plurality of gaming terminals 1, and determines the gaming terminal 1 to which the jackpot is paid out.

### TECHNICAL FIELD

The present invention relates to a gaming system, management device, gaming terminal, and a method and program for jackpot payout, wherein the jackpot payout is distinctive.

### BACKGROUND ART

A system called a jackpot, wherein a large number of gaming machines such as slot machines are inter-linked, a certain percentage of the medals bet to each gaming machine is pooled together, and the pooled portion is paid out at once when a particular combination which has a small probability of appearing has been established, has been known traditionally in casinos in Las Vegas and the like. The jackpot enables the sudden acquisition of a large sum of money which is impossible to acquire from a single gaming machine and is something which holds enormous appeal to the player. This jackpot system is implemented, in Japan, in medal gaming machines such as slot machines and poker which are installed in arcades, as well. A system such as this is sometimes called a progressive system.

A jackpot, if it occurs often, is boring because the amount of medals pooled is small, and on the other hand, it is also a problem if the desire of the player to win the jackpot is lost because too strict of conditions are set. In addition, although an element of surprise, in that a jackpot is generated suddenly without any warning, is a characteristic of a jackpot and its appeal, at the same time, the mentality to seek the jackpot is not very active in players while they are playing, and influence on enabling the players to become passionate about the progression of the game, per se, was weak.

Given these factors, in the gaming system described in Patent Reference 1, below, the right to take on a game for a special lottery to win the jackpot is given to those who have met relatively simple conditions, the jackpot is awarded by winning this game, and the progression of the lottery game is made known to the other players present. Furthermore, in the game system described in Patent Reference 2, below, a jackpot item is generated when relatively simple conditions are cleared, a jackpot is awarded when a predetermined amount of jackpot items have been collected by all of the linked gaming machines, and the collection status of the jackpot items is displayed in the display means and can be known to all players.
Patent Reference1 Japanese Patent Laid-Open Publication 10-328354
Patent Reference2 Japanese Patent Laid-Open Publication 2002-85811

### DISCLOSURE OF THE INVENTION

In the gaming system described in Patent Reference 1, above, while someone is taking on the lottery game, other players can only watch this. In addition, the person who has obtained the right to take on this lottery game him/herself often loses this game, resulting in premature joy. In the gaming system described in Patent Reference 2, above, the original appeal of the jackpot is diminished because the approximate timing of the generation of a jackpot is known to the player, and results in the game picking up momentum only when jackpot items have been accumulated to some extent.

The present invention has been made with the actual situations described above in mind, and the objective thereof is to provide a gaming system, management device, gaming terminal, and a jackpot payout method and program which is rich in entertainment value, wherein all of the players can become passionate about winning the jackpot and a heated game can be unfolded while maintaining the appeal of the jackpot in that no one knows when it will occur.

The gaming system according to the present invention, which comprises a plurality of gaming terminals for collecting medals and the like to execute the game and paying out prizes according to game results and a management device for the jackpot which is connected to this plurality of game terminals to enable communication, executes a special game which is solely for the purpose of competing for the jackpot in the plurality of gaming terminals when the management device determines jackpot payout to be possible and determines the gaming terminal to which the jackpot is paid out. Here, medals and the like refer to medals, coins, paper money, magnetic cards, points or the like, which are required for the player to play the game. Prizes can be medals, the amount of which is set based on game results, and can also be predetermined prize items (comprising the right to obtain medals and the like and prize items and the like). In addition, the jackpot is a concept which represents a special value given to the player, and does not necessarily have to be medals and the like, but can be special prize items, as well. Furthermore, although a gaming terminal can be a separate and independent gaming machine, such as a slot machine and poker, in regards to so-called multiple-player game machines which have a plurality of player positions in one gaming machine, such as horse-racing games and roulette games, each player position is equivalent to one gaming terminal. No distinctions are made regarding the type of game played in the gaming terminal. The special game is held separately from the normal game and is continued until someone wins the jackpot, regardless of the prize and the odds of the normal game.

According to the present invention, a heated jackpot competition (special game) unfolds between a plurality of players when a state wherein jackpot payout is possible is reached, and because the jackpot can be won without fail by winning this game, a particular gaming-experience which is filled with excitement can be provided to a large number of players.

In one aspect of the present invention, in a gaming system which comprises a plurality of gaming terminals for collecting medals and the like to execute the game and paying out prizes according to game results, and a management device for the jackpot which is connected to this plurality of gaming terminals to enable communication, a jackpot payout timing detection means for determining whether or not jackpot payout is possible is comprised in the management device, a special game execution means for executing a special game, which is solely for the purpose of competing for the jackpot between a plurality of gaming terminals, when the fact that jackpot payout is possible is acknowledged through information from the management device, is comprised in each gaming terminal, and a jackpot payout destination determination means for determining the gaming terminal to which the jackpot is paid out based on the result of the special game transmitted from the gaming terminals is comprised in the management device.

In addition, in one aspect of the present invention, said management device comprises a jackpot accumulation means for accumulating a portion of the medals and the like inserted in to the gaming terminals as the jackpot and determines that jackpot payout is possible by accumulating the jackpot to more than a certain amount. Through this, the interval between the occurrences of jackpots does not become too short nor too long, and there is no unfairness due to the value of the jackpot differing every time.

Furthermore, in one aspect of the present invention, said management device determines that jackpot payout is possible under the condition that more than a certain number of gaming terminals must be in play, in addition to accumulating the jackpot to more than a certain amount. Through this, the special game is always competed for between more than a certain number of players, and therefore, a heated game can be ensured.

Additionally, in one aspect of the present invention, the gaming system comprises a notification means for notifying players that a special game will be held. The notification means notifies players of information regarding the special game through presentation on display screens and announcements through speakers and the like, and can be comprised separately in each gaming terminal or can be provided separately from the gaming terminals. It is preferable for the notification means to notify the players of the rules of the special game (how the jackpot can be won) in time with the holding of the game.

In addition, if said notification means performs a countdown to the start of the special game, it will be effective in further building up the excitement of the players.

Said special game can be made to enable participation from all of the gaming terminals, but can also be made to enable only the gaming terminals which are playing immediately prior to when jackpot payout becomes possible to play. In this case, attempts only to win the jackpot without playing the normal game are unsuccessful, and participation of players seeking the jackpot in normal games can be promoted.

In addition, the management device according to the present invention which collects medals and the like to execute games, is connected to a plurality of gaming terminals which pay out prizes according to game results and manages the jackpot which is paid out to these gaming terminals, comprises a jackpot timing detection means for determining whether or not jackpot payout is possible, an acknowledgement means for making the gaming terminals acknowledge that jackpot payout is possible, and a jackpot payout destination means for determining the gaming terminal to which the jackpot is paid out based on the results of the special game which held is solely for the purpose of competing for the jackpot in the plurality of gaming terminals when jackpot payout is determined to be possible.

Furthermore, the gaming terminal according to the present invention collects medals and the like to execute games, pays out prizes according to game results; and at the same time, in a gaming terminal wherein a jackpot win occurs, the gaming terminal is connected in plural numbers to the management device which manages the jackpot to allow communication and, when the fact that jackpot payout is possible is acknowledged through information from the management device, comprises a special game execution means for executing a special game which is solely for the purpose of competing for the jackpot in the plurality of gaming terminals and a means for transmitting the results of the special game to the management device.

In addition, the method according to the present invention is a jackpot payout method wherein a plurality of gaming terminals which collects medals and the like to execute games and pays out prizes according to game results is connected to the jackpot management device to enable communication, the jackpot managed by the management device is paid out to a gaming terminal, the management device comprises a step for determining whether or not jackpot payout is possible, a step for making the plurality of gaming terminals acknowledge that jackpot payout is possible, a step for executing the special game which held is solely for the purpose of competing for the jackpot in the plurality of gaming terminals, and a step for determining the gaming terminal to which the jackpot is paid out by the management device based on the results of the special game.

In addition, the program according to the present invention is a program for the purpose of enabling a computer which is connected to the plurality of gaming terminals, which collects medals and the like to execute a game and pays out the jackpot based on the game results, to function as the management device for the jackpot which is paid out to these gaming terminals and to enable said computer to execute a step for determining whether or not jackpot payout is possible, a step for making the plurality of gaming terminals acknowledge that jackpot payout is possible, and a step for determining the gaming terminal to which the jackpot is paid out based on the results of the special game which held is solely for the purpose of competing for the jackpot in the plurality of gaming terminals when jackpot payout is determined to be possible.

Furthermore, the program according to the present invention is a program for the purpose of enabling a computer, which is connected to the jackpot management device to enable communication, to function as the game terminal wherein the jackpot win occurs, and enables the computer to execute a step which acknowledges that jackpot payout is possible through information from the managing device, a step for executing the special game for the sole purpose of jackpot competition in a state wherein jackpot payout is possible, and a step for transmitting the special game results to the management device.

### BRIEF DESCRIPTION OF THE DRAWINGS

FIG. 1 is a block diagram showing the control system of a gaming system of the present invention;

FIG. 2 is an outline view schematically showing the configuration of the gaming system of the present invention;

FIG. 3 is an explanatory diagram explaining a structure for controlling ascertaining the number of gaming terminals in play;

FIG. 4 is one example of the notification of a special game which is presented on the display screen of a notification means;

FIGS. 5A, 5B, 5C, and 5D is one example of the display on the display screen of a gaming terminal, from the notification of the special game to end;

FIG. 6 is a flow chart which shows the flow of processing in a gaming system of the present invention;

FIG. 7A is a top view of another embodiment of the gaming system according to the present invention;

FIG. 7B is an elevation view of another embodiment of the gaming system according to the present invention;

FIG. 8 is a schematic block diagram of the gaming system according to the embodiment in FIG. 7;

FIG. 9 is a diagram showing an image presented on a bet display table during a normal game;

FIG. 10A is a diagram showing an image presented on a bet display table immediately before the start of a special game;

FIG. 10B is a diagram showing an image presented on a bet display table immediately after the end of a special game;

FIGS. 11A, 11B, and 11C, is a diagram showing a sequence of display screens of the gaming terminals in another embodiment.

### BEST MODE FOR CARRYING OUT THE INVENTION

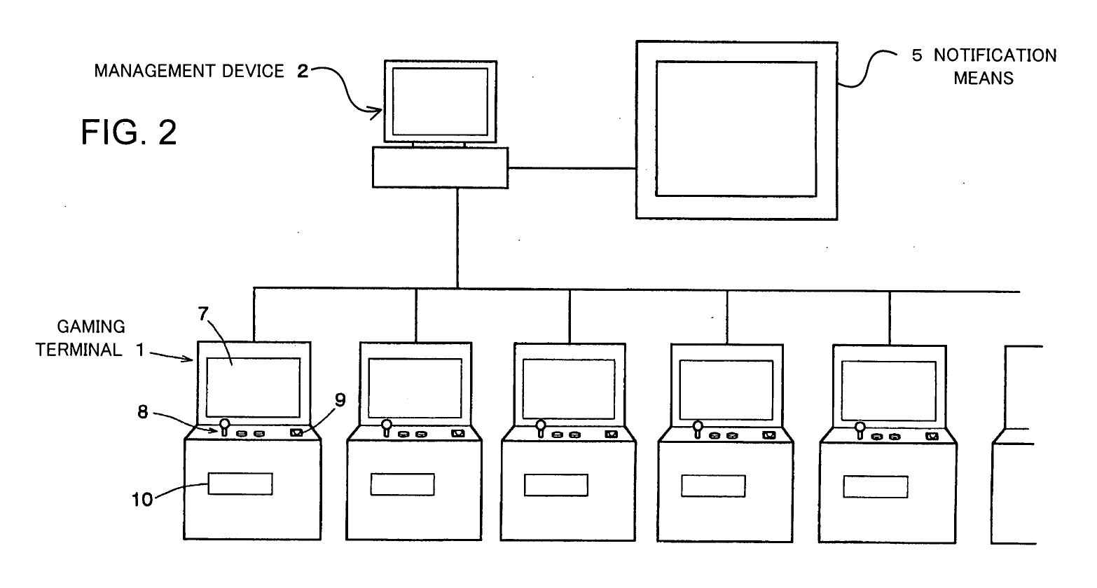

The embodiments of the present invention are explained below, in reference to the diagrams. FIG. 2 is an outlive view which schematically shows the configuration of a gaming system of the present invention. This gaming system comprises a plurality of gaming terminals 1 wherein a medal is inserted to play a game, one management device 2 which manages these game terminals 1, and a notification means 5 which notifies players of information regarding a special game for the purpose of winning a jackpot which is held when predetermined conditions are met. Each gaming terminal 1 and the management device 2 are connected by wired or wireless electrical communication lines and exchange necessary data with each other. The management device 2 can also be installed in one of the plurality of gaming terminals 1. In addition, the present system can connect a number of gaming terminals 1 which are arranged in one place in an arcade or the like to the management device 2 or can connect an even larger number of gaming terminals 1 which are scattered over a wide area to the management device 2. The gaming terminal 1 comprises a display screen 7 for displaying game content, an operation part 8 by which players perform game operations, a medal slot 9, a medal payout outlet 10 and the like. Although no distinctions are made regarding the type of games executed in the gaming terminal 1, here, a Japanese Hanafuda card game is explained. The players bet medals and play a game with a virtual opponent within the display screen 7, and medals are paid out according to game results.

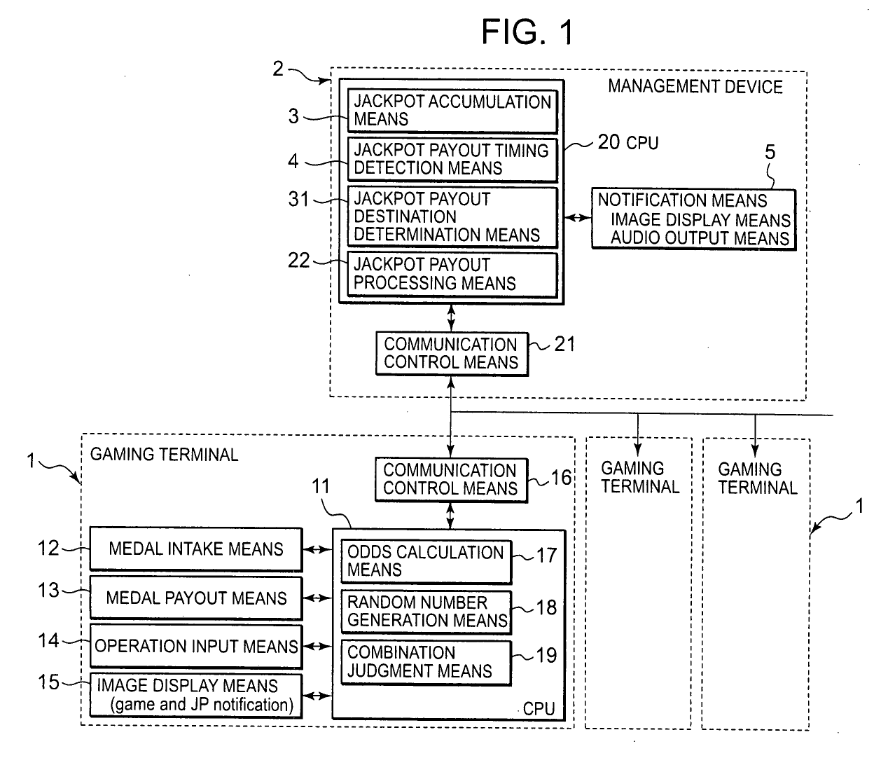

FIG. 1 is a schematic block diagram of the control system of this gaming system. The block configuration of each gaming terminal 1 is the same and the control system comprises a CPU 11, and a medal deposit-taking means 12, a medal payout means 13, an operation input means 14, an image display means 15, and a communication control means 16 which are connected to the CPU 11. The CPU 11 is configured by a combination of a microprocessor and various peripheral chips, memory such as ROM and RAM, and other peripheral components which are required for the operations. The CPU 11 performs control of various calculations and each of the afore-mentioned means which are required for the game process, in accordance to a program stored in ROM. The program comprises a program for executing a normal game and a program for executing a special game which is explained hereafter, and the gaming terminal 1 not only executes the aforementioned normal game, but also functions as a special game execution means. In addition, the results of the special game are sent to the management device 2 via the communication control means 16.

The medal deposit-taking means 12 outputs a signal indicating the insertion to the CPU 11 when a medal is inserted into the medal slot 9 and sends the medal to a predetermined depository. The medal payout means 13 takes out the number of medals instructed by the CPU 11 from the depository and sends the medals to the medal payout outlet 10. The operation input means 14 outputs signals according to the operation of the buttons and levers of the operation section 8 by the player to the CPU 11. The image display means 15 comprises a driver circuit, which is required for a display screen and the display control thereof, and displays necessary information on the display screen 7 according to instructions from the CPU 11. The communication control means 16 performs data communication to the management device 2 according to instructions from the CPU 11.

The interior of the CPU 11 comprises an odds calculation means 17, a random number generation means 18, and a combination determination means 19, depending on the combination of the microprocessor and specific software. Odds calculation means 17 calculates the number of medals to be distributed for each winning combination based on the number of medals bet. The random number generation means 18 generates random numbers required for the game process, and the cards dealt to the player is determined based on these numbers. The combination determination means 19 determines whether or not predetermined combinations stored within ROM is attained during the game process.

Furthermore, the control system of the management device 2 comprises a CPU 20, and a notification means 5 and a communication control means 21 which are connected to the CPU 20. The CPU 20 is configured by a combination of a microprocessor and various peripheral chips, memory such as ROM and RAM, and other peripheral components which are required for the operations. The CPU 20 performs control of various calculations and each of the afore-mentioned means which are required for jackpot management, in accordance to a program stored in ROM. The notification means 5 notifies players of information regarding the special game which determines the winner of the jackpot by display through display screens and announcements from speakers. The communication control means 21 performs data communication to the gaming terminal 1 according to instructions from CPU 20

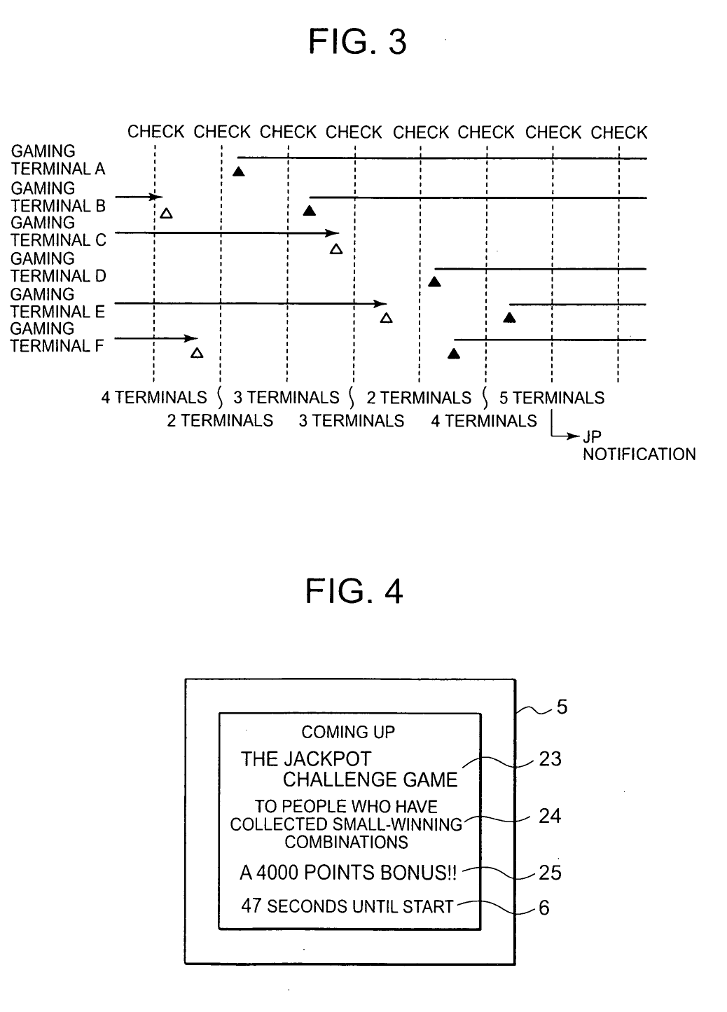

The interior of CPU 20 comprises a jackpot accumulation means 3, a jackpot payout timing detection means 4, a jackpot payout destination determination means 31, and a jackpot payout processing means 22, depending on the combination of the microprocessor and specific software. The jackpot accumulation means 3 tallies up the total number of medals inserted into each gaming terminal 1, allots a certain percentage of the total to the jackpot and collectively accumulates the medals. The jackpot payout timing detection means 4 determines that a jackpot payout is possible under conditions that more than a certain number of medals are accumulated and more than a certain number of gaming terminals 1 are in play, and outputs a signal for starting the special game to the notification means 5 and each of the gaming terminals 1. For this purpose, as shown in FIG. 3, CPU 20 checks how many numbers of gaming terminals are currently in play at certain time intervals, and deems the time from when the start button of each gaming terminal 1 has been pressed (▴ within the diagram) to the time when the play out button has been pressed (Δ within the diagram) as in play, and in the example in the diagram, jackpot payout is determined to be possible when more than five gaming terminals are in play.

The special game is a special game which is held in each gaming terminal 1 for the sole purpose of determining the gaming terminal 1 to which the jackpot is paid out when jackpot payout becomes possible, and is held regardless of the odds and prizes of the normal game. The special game is, for example, a game for competing to attain a predetermined combination first, a game for competing how many points are won within a limited time, or a game for predicting first place in a horse racing game. Information regarding the special game held in each gaming terminal 1 is sent to the management device as needed, and the jackpot payout destination means 31, which is comprised in the management device, determines which gaming terminal 1 has the best score based on said information and determines the gaming terminal 1 to which the jackpot is paid out. The jackpot payout process means 22 performs processing for paying out the jackpot accumulated by the jackpot accumulation means 3 to this gaming terminal 1 and processing to enable the other gaming terminals 1 and the notification means 5 to notify the completion of the special game. The jackpot can be awarded to the one gaming terminal 1 with the best special game score only or divided and awarded to a number of gaming terminals 1.

The special game can be made to be executed by all of the gaming terminals 1 connected to the management device 2 or can be made to be executed only by game terminals 1 which are in play at the time the management device 2 determines jackpot payout to be possible. As stated earlier, because the management device 2 has knowledge of the gaming terminals 1 which are currently in play, if special game execution signals are not sent to gaming terminals 1 which are not in play, the special game can be held in this state.

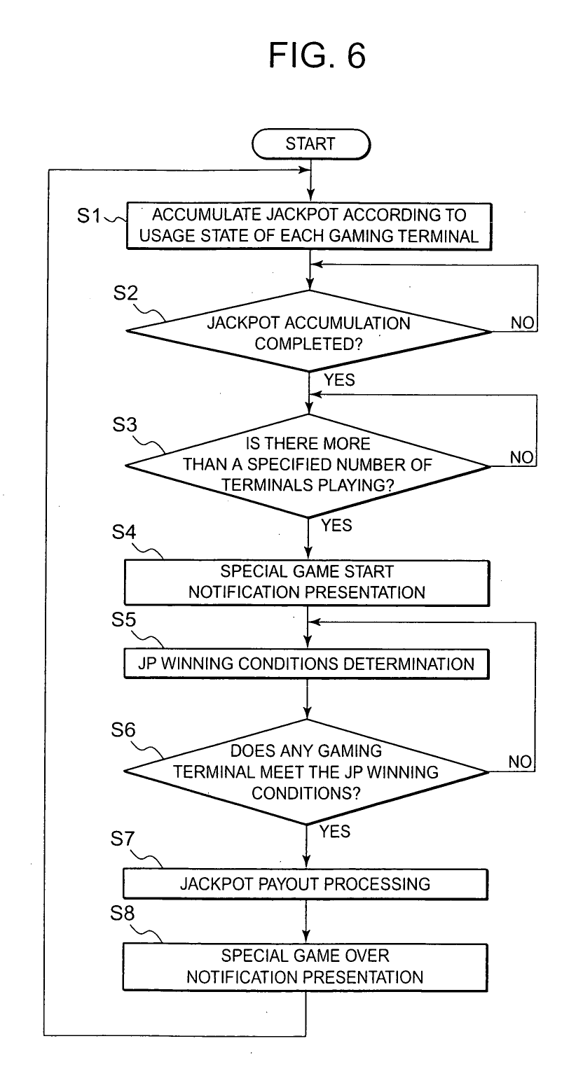

Next, the processing performed by the present gaming system is explained in reference to the flowchart in FIG. 6, centering on parts related to the jackpot. In step S1, each gaming terminal 1 is in a state of operation, individually executing a normal game, and the jackpot accumulation means 3 within the management device CPU 20 sequentially accumulates the jackpot by the insertion of medals into each gaming terminal 1. After the jackpot is determined to have reached a predetermined value in step S2, the process moves to step S3 and determines whether or not more than a predetermined number of gaming terminals 1 are in play. If jackpot payout is determined to be possible through this step, the process proceeds to step S4, the management device 2 outputs instructions to each gaming terminal 1 and the notification means 5, and a start notification presentation for the special game is made.

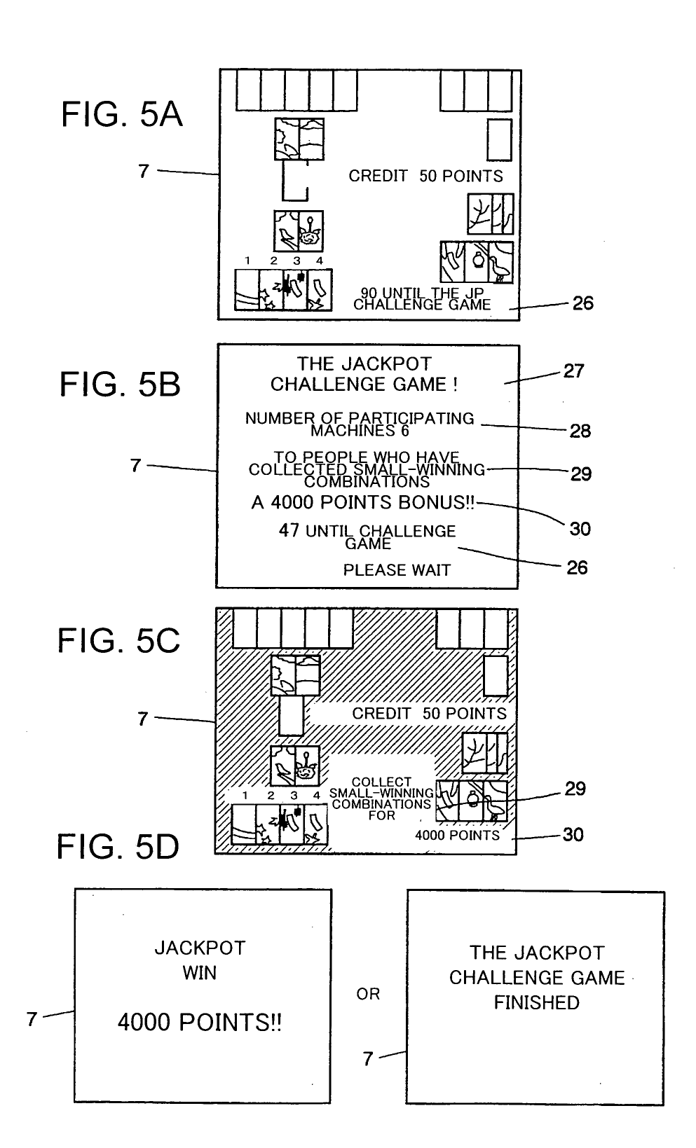

The content of the start notification presentation is, as shown in FIG. 4 for example, displaying a display 23 of the fact that a special game will be held, condition 24 for winning the jackpot bonus, the jackpot bonus value 25, and countdown 6 on the display screen of the notification means 5, and at the same time, these information are announced over the speakers of the notification means. Furthermore, as shown in FIG. 5A, countdown 26 to the start of the special game is displayed on the display screen 7 of each gaming terminal 1. The display screen 7 of gaming terminals 1 which have finished its current game during the countdown and gaming terminals 1 which are currently not in use become a standby screen such as that shown in FIG. 5B. In this screen, a display 27 of the fact that a jackpot competition game will be held, the number 28 of participating terminals, the conditions 29 for winning, the jackpot bonus value 30 and the countdown 26 are displayed. The special game is started in all terminals simultaneously when the countdown reaches zero. FIG. 5C shows the display screen 7 of the gaming terminal while the special game is being held, and the player plays the special game, concentrating on winning the jackpot. Play status data of the special game is sent to the management device, and determination of jackpot winning conditions (step S5) is performed. The special game attempts differentiation from the normal game through changing the background color.

The special game can be played repeatedly until someone wins the jackpot. In addition, bets are collected during the special game, as well, and are accumulated for the next jackpot. It is preferable that the winning conditions be relatively easy to meet because interest will wane if the special game continues endlessly for a long time. If the winning conditions are met by any of the gaming terminals 1 in step S6, the process moves to step S7, the management device 2 performs jackpot payout processing to this gaming terminal 1, and this amount is subtracted from the jackpot value of the jackpot accumulation means 3 comprised within the management device 2. Next, the process proceeds to step S8, the management device 2 outputs instructions to each gaming terminal 1 to finish the special game and makes a finish notification presentation of the special game in the game terminals 1 and the notification means 5. The finish notification presentation, as shown in FIG. 5D, displays the fact that it has won to the display screen 7 of the gaming terminal which won the jackpot and displays the fact that the special game is finished to the display screen 7 of the other gaming terminals. After this, the process returns to step S1 and returns to a normal game state.

In addition, the special game can be made to be played for free, without collecting bets from players. In this case, game terminals wherein the special game is executed are restricted, such as by allowing the special game to be played only in game terminals which have been in play immediately before jackpot payout became possible.

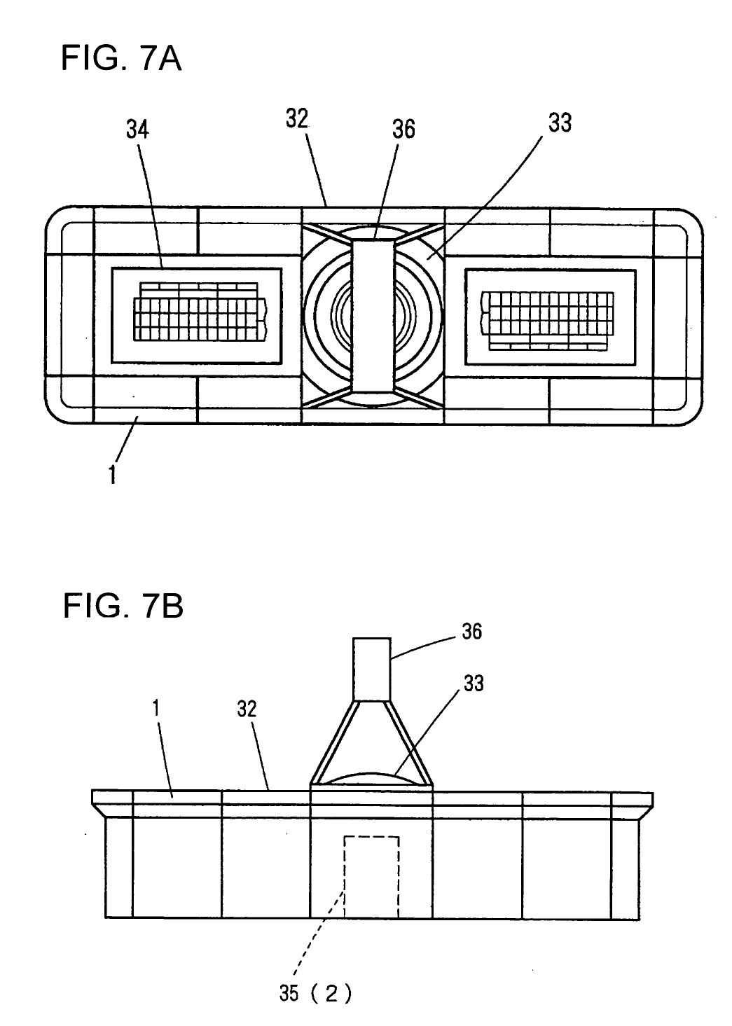

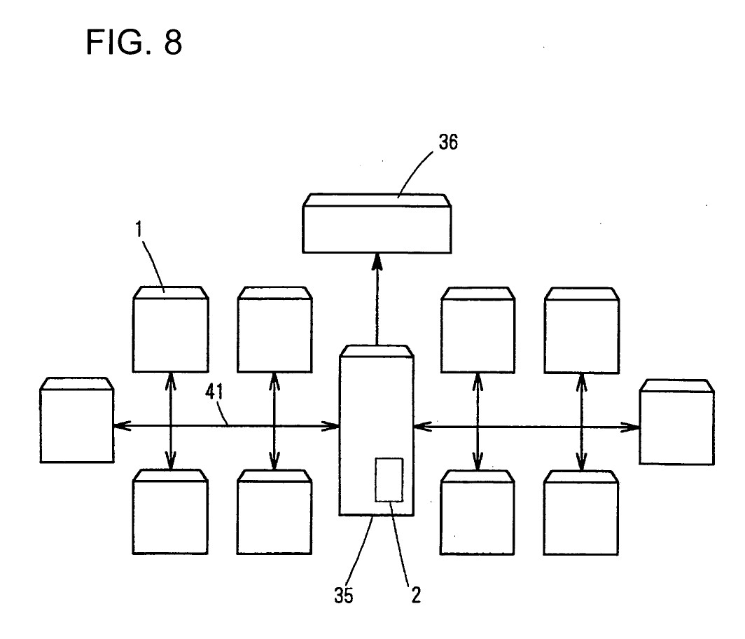

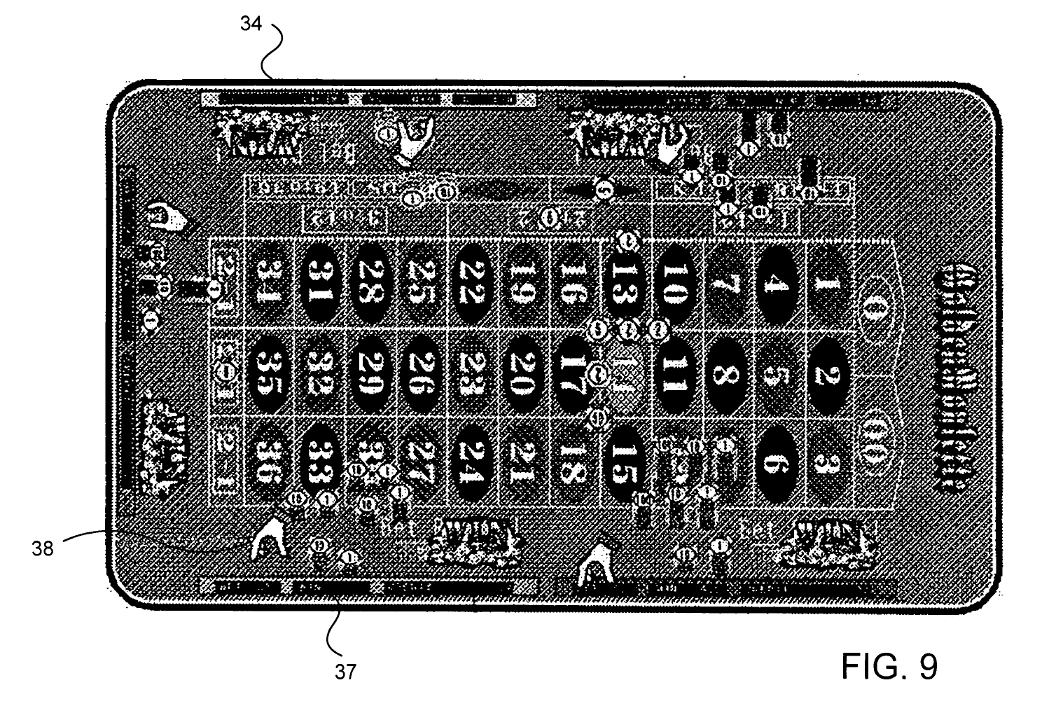

FIG. 7 to FIG. 10 show another embodiment of the gaming system according to the present invention. This system is configured to enable a plurality of people to play a roulette game simultaneously, comprises a roulette wheel in the center of a table-shaped frame 32 and a bet display table 34 on the table on both sides of the roulette wheel 33, and ten gaming terminals 1 for players to participate in the roulette game surround the frame 32, arranged to encompass the table. The interior of the frame 32 comprises a host machine 35 which is connected to each gaming terminal 1 by electric communication lines 41, and the host machine 35 performs rotation control of the roulette wheel 33, image display of the bet display table 34, and output of game process announcements from the speakers, as well as collecting game information from each game terminal 1, and enables the execution of the roulette game by collecting bets and paying out prizes. The host machine 35 also comprises functions as the jackpot management device 2, as in the embodiment explained earlier, detects the jackpot payout timing, as well as enables the gaming terminals 1 to execute the special game for jackpot competition and pays out the jackpot to a gaming terminal 1. Symbol 36, within the diagram, is a jackpot score display device, to which the jackpot value is displayed while the special game is being played.

In normal games, credit 37 and cursor 38 for each gaming terminal 1 is displayed in the bet display table 34, as shown in FIG. 9. The roulette wheel 33 automatically starts at regular time intervals. The player operates the cursor 38, which is on the table, through the operation input means comprised in each game terminal 1 and bets his/her credit within a time frame. When the roulette wheel 33 stops and a winning number is determined, the host machine determined the win/lost of every gaming terminal 1 and performs bet collection and prize payout processing to each gaming terminal 1.

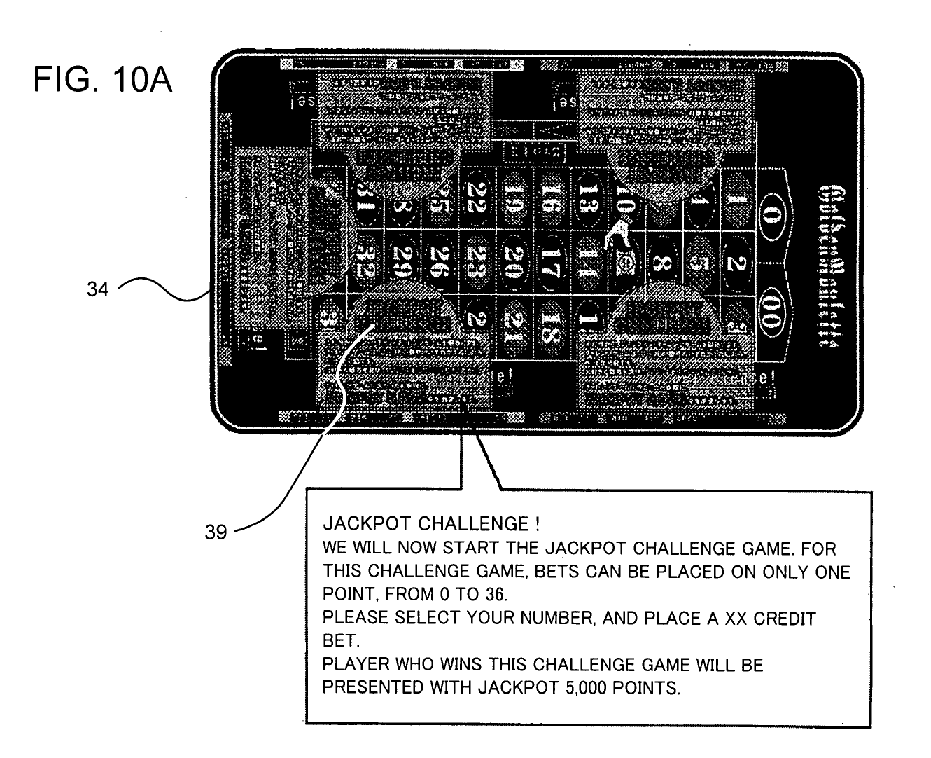

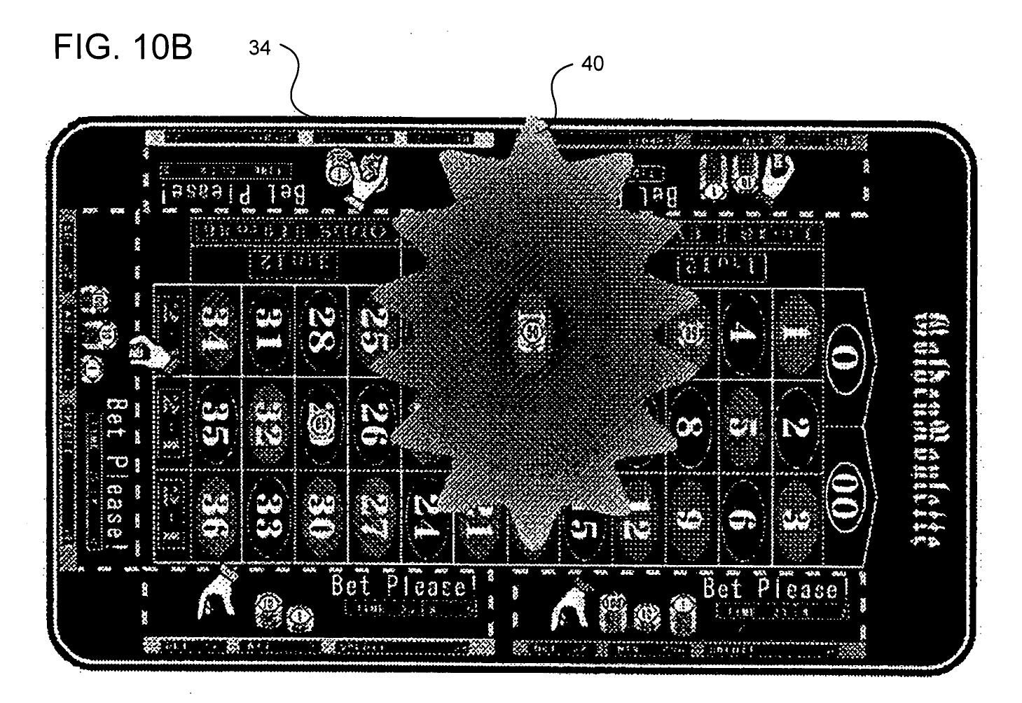

When predetermined conditions have been cleared and jackpot payout has been determined to be possible, the host machine 35 starts the special game after performing a start notification presentation display 39 for the special game, such as that shown in FIG. 10A, in the bet display table 34, after the current game has been finished. Bet time is entered simultaneously with the start of the special game, and players can bet predetermined credit on only one position within any of the numbers 0 to 36 on the bet display table 34. When bet time is over, the roulette wheel 33 starts automatically. When the roulette wheel stops and a winning number is determined, if there is a winning player, a jackpot win display 40, such as that shown in FIG. 10B, is displayed on the bet display table 34, and the score of the jackpot score display device 36 is added to the credits of the winning player. The special game is repeatedly held until a winning player emerges. The special game ends with the game wherein a winning player emerges and returns to a normal game state.

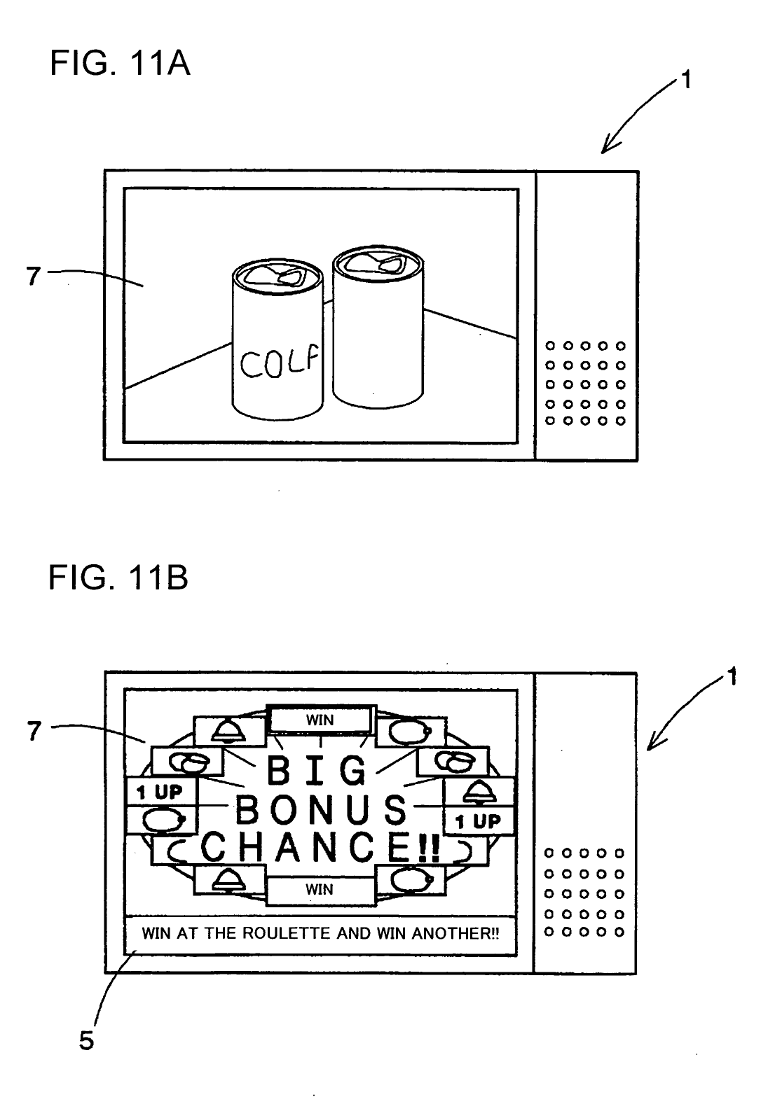

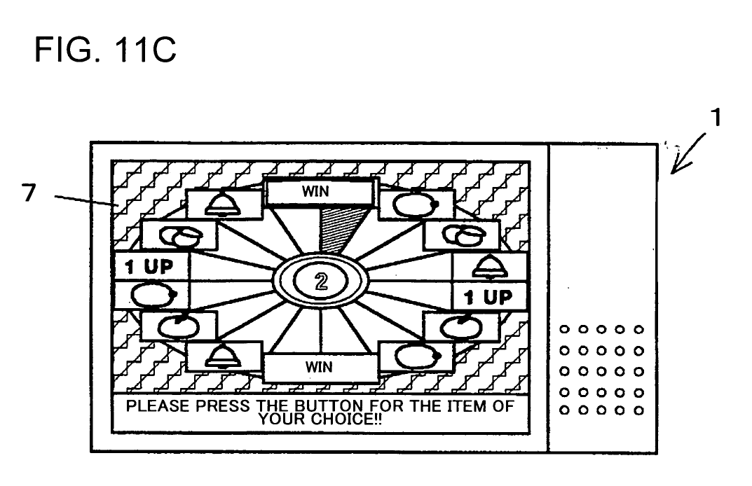

The gaming system of the present invention can be applied to medal gaming machines, such as poker and slot machines, wherein a game is held by betting medals, a multiple-player gaming machine, such as horse-racing games and roulette games which can be played simultaneously by a plurality of players, a prize gaming machine wherein various games are held by inserting coins and prize items such as stuffed animals are sought, Japanese pinball and slot machines, product automatic vending machines which comprise gaming functions and the like. An embodiment for application in product automatic vending machines is explained below, in reference to FIG. 11.

1, within the diagram, indicates a compact gaming terminal installed in the front surface of a product automatic vending machine, and gaming terminals 1 which are comprised in a large number of automatic vending machines distributed in separate locations are linked to one management device through electric communication lines. Product advertisements and the like are normally displayed in a liquid crystal display screen 7 of the gaming terminal 1. The gaming terminal 1 comprises a means for detecting the insertion of coins, and this information is sent to the management device. The management device accumulates jackpot points based on this data. When more than a certain amount of jackpot points are accumulated, the image display of the gaming terminal 1 changes to the state shown in FIG. 11B by instructions from the management device. When a product is purchased at this time, the customer can play a special game (a roulette game in this example), and if the game is won as shown in FIG. 11C, the product purchaser can obtain a prize item.

### INDUSTRIAL APPLICABILITY

In the gaming system and the like according to the present invention, when a state wherein a jackpot payout is possible is reached, a heated jackpot competition (special game) is unfolded between a plurality of players, and because the jackpot can definitely be won by winning this competition, a particular gaming experience filled with excitement can be provided to a large number of players.

Furthermore, if the gaming system is one wherein a management device determines jackpot payout to be possible by accumulating the jackpot to more than a certain amount, the frequency of the generation of a jackpot can be controlled to some extent, and there is no unfairness due to the jackpot value differing each time, and also, the original appeal of the jackpot is not diminished because the player cannot predict when a special game will occur.

In addition, if the management device determines a jackpot payout to be possible under the condition that more than a certain number of gaming terminals must be in play, in addition to the condition that the jackpot must be accumulated to more than a certain amount, the special game can definitely become a heated game because the jackpot will inevitably be competed for with more than a certain number of other players.

Furthermore, if the gaming system comprises a notification means for notifying players that a special game will be held, the existence of the jackpot and the special game for winning the jackpot can be strongly impressed upon the players, the passion for gambling within the players can be fueled, and players' interest in the game can be aroused. In addition, if the notification means performs a countdown for the start of the special game, it is effective in further boosting the excitement of the players.

In addition, by allowing the special game to be played only by gaming terminals in play immediately before jackpot payout becomes possible, attempts only to win the jackpot without playing the normal game are unsuccessful, and participation in normal games can be promoted to players seeking the jackpot.

1. (canceled)

2. A gaming system comprising:
a plurality of gaming terminals which collect medals and the like to execute a game and pays out prizes according to game results; and
a management device for a jackpot which is connected to these plural gaming terminals to enable communication; wherein
a jackpot payout timing detection means for determining whether or not jackpot payout is possible is comprised in the management device;
a notification means for notifying players that a special game will be held when jackpot payout becomes possible is comprised in the management device;
a special game execution means for executing a special game, which is solely for the purpose of competing for the jackpot between a plurality of gaming terminals, when the fact that jackpot payout is possible is acknowledged through information from the management device is comprised in each gaming terminal;
a jackpot payout destination determination means for determining the gaming terminal to which the jackpot is paid out based on the result of the special game transmitted from the gaming terminals is comprised in the management device; and
a means for controlling each gaming terminal to continue executing the special game until the jackpot is paid out is comprised in the management device.

3. The gaming system according to claim 2, wherein said management device comprises a jackpot accumulation means for accumulating a portion of the medals and the like inserted in to said gaming terminals as the jackpot and determines jackpot payout to be possible by accumulating the jackpot to more than a certain amount.

4. The gaming system according to claim 3, wherein said management device determines jackpot payout to be possible under the condition that more than a certain number of gaming terminals must be in play, in addition to accumulating a jackpot to more than a certain amount.

5. (canceled)

6. The gaming system according to claim 2, wherein said notification means performs a countdown to the start of a special game.

7. The gaming system according to claim 2, wherein said special game can be played only by gaming terminals which were in play immediately prior to when jackpot payout became possible.

8. A management device, which collects medals and the like to execute games, is connected to a plurality of gaming terminals which pay out prizes according to game results and manages a jackpot which is paid out to these gaming terminals, comprising:
a jackpot timing detection means for determining whether or not jackpot payout is possible;
a notification means for notifying players that a special game will be held, when jackpot payout becomes possible;
an acknowledgement means for making the gaming terminals acknowledge that jackpot payout is possible;
a jackpot payout destination means for determining the gaming terminal to which the jackpot is paid out based on the results of the special game which held is solely for the purpose of competing for the jackpot in the plurality of gaming terminals when jackpot payout is determined to be possible; and
a means for controlling each gaming terminal to continue executing the special game until the jackpot is paid out.

9. A gaming terminal which collects medals and the like to execute games, pays out prizes according to game results, and is connected in plural numbers to a management device which manages a jackpot to enable communication, comprising, when the fact that jackpot payout is possible is acknowledged through information from the management device:
a notification means for notifying players that a special game will be held;
a special game execution means for executing a special game which is solely for the purpose of competing for the jackpot in the plurality of gaming terminals;
a means for transmitting the results of the special game to the management device; and
when instructions to continue executing the special game until the jackpot is paid out is received from the management device:
a means for continuing the execution of the special game.

10. A jackpot payout method wherein a plurality of gaming terminals which collects medals and the like to execute games and pays out prizes according to game results is connected to a jackpot management device to enable communication, and the jackpot managed by the management device is paid out to a gaming terminal, wherein the management device comprises:
a step for determining whether or not jackpot payout is possible;
a step for making the plurality of gaming terminals acknowledge that jackpot payout is possible;
a notification step for notifying players that a special game will be held, when the jackpot payout becomes possible;
a step for executing a special game which held is solely for the purpose of competing for the jackpot in a plurality of gaming terminals;
a step for determining the gaming terminal to which the jackpot is paid out by the management device based on the results of the special game; and
a step for controlling each gaming terminal to continue executing the special game until the jackpot is paid out.

11. A program for the purpose of enabling a computer which is connected to a plurality of gaming terminals, which collects medals and the like to execute a game and pays out the jackpot based on the game results, to function as a management device for a jackpot which is paid out to these gaming terminals and enabling said computer to execute:
a step for determining whether or not jackpot payout is possible;
a notification step for notifying players that a special game will be held, when the jackpot payout becomes possible;
a step for making the plurality of gaming terminals acknowledge that jackpot payout is possible;
a step for determining the gaming terminal to which the jackpot is paid out based on the results of a special game which held is solely for the purpose of competing for the jackpot in a plurality of gaming terminals when jackpot payout is determined to be possible; and
a step for controlling the plurality of gaming terminal to continue executing the special game until the jackpot is paid out.

12. A program for the purpose of enabling said computer to function as a game terminal, which is connected to a jackpot management device to enable communication and wherein a jackpot win occurs, and enabling the computer to execute:
a step for acknowledging that jackpot payout is possible through information from the managing device;
a notification step for notifying players that a special game will be held, when the jackpot payout becomes possible;
a step for executing a special game for the sole purpose of jackpot competition in a state wherein jackpot payout is possible;
a step for transmitting the special game results to the management device; and
a step for continuing the execution of the special game when instructions to continue executing the special game until the jackpot is paid out is received from the management device.
